(19) United States
(12) Patent Application Publication
(10) Pub. No.: US 2026/0035225 A1
(43) Pub. Date: Feb. 5, 2026

(54) SYSTEM AND KIT FOR MOUNTING A FORKLIFT TO A TRUCK

(71) Applicant: Konik Heavy Duty Products, Lafayette, IN (US)

(72) Inventors: THOMAS DAVIS, Lafayette, IN (US); RAMON VILLALOBOS, Lafayette, IN (US)

(21) Appl. No.: 19/288,078

(22) Filed: Aug. 1, 2025

Related U.S. Application Data
(60) Provisional application No. 63/678,792, filed on Aug. 2, 2024.

(51) Int. Cl. B66F 9/075

(52) U.S. Cl. CPC B66F 9/07563

(57) ABSTRACT

A system for mounting a forklift to a vehicle having a frame. The system includes a core assembly to receive and hold securely a pair of forks of a forklift, a plurality of flange shims to adjust a width dimension of a first part of the core assembly to match a width of the frame, and a plurality of tire pad shims to adjust a width dimension of a second part of the core assembly to match the width of the frame. The core assembly, the plurality of flange shims, and the plurality of tire pad shims are each configured to bolt to each other and the core assembly is configured to bolt to the frame. The first part of the core assembly can include a bar. The second part of the core assembly can include a support tube or bumper.

### CROSS REFERENCE TO PRIOR APPLICATION

This application claims priority to, and the benefit thereof, provisional U.S. Patent Application Ser. No. 63/678,792, filed on Aug. 2, 2024, the entirety of which is hereby incorporated herein by reference as if fully set forth herein.

### TECHNICAL FIELD

The present disclosure relates generally to a system and a kit for mounting a forklift to a truck without cutting or welding the core assembly for installation.

### BACKGROUND

Truck mounted forklifts have become commonplace. Typically, a forklift mount system is installed to a backend of a truck by cutting and welding parts of the forklift mount to the backend. FIG. 1 shows an example of a forklift mount 30 installation on the truck backend, with the remainder of the truck omitted. The forklift mount 30 is installed by cutting and welding parts to the frame 50 and bed 10 of the truck.

As seen in FIG. 1, once the forklift mount 30 is installed on the backend, a forklift 40 can engage the forklift mount 30 by sliding the forks 41 into the mount until forks and mast 42 are properly seated. After proper seating, the forklift 40 can be controlled to lower the forks 41, which in turn lifts the entire forklift 40 until the chassis 43 is at a predetermined height from the ground, at which point the mast 42 can be controlled to tilt the forklift 40 toward the truck backend.

Since installation of forklift mounts 30 requires significant cutting and welding, the installation process is lengthy, costly, and requires a skilled welder. A need exists for an inexpensive and easily installable forklift mount installation that does not require any cutting or welding.

### SUMMARY

The instant disclosure provides a novel system and kit for installation on a truck backend without any need for cutting or welding, including for trucks or trailers having frames with different dimensions. The disclosure also provides a method for installing the kit on the backend, without cutting or welding.

According to an aspect of the disclosure, a system is provided for mounting a forklift to a vehicle having a frame. The system comprises a core assembly configured to receive and hold securely a pair of forks of a forklift, a plurality of flange shims configured to adjust a width dimension of a first part of the core assembly to match a width of the frame, and a plurality of tire pad shims configured to adjust a width dimension of a second part of the core assembly to match the width of the frame. The core assembly, the plurality of flange shims, and the plurality of tire pad shims can each be configured to bolt to each other, and wherein the core assembly can be configured to bolt to the frame.

The first part of the core assembly can comprise a bar. The second part of the core assembly can comprise a support tube or bumper.

The plurality of flange shims can include at least four flange shims. The plurality flange shims can include at least two flange shims having a thickness of ¼″. The plurality flange shims can include at least two flange shims having a thickness of 10 GA. The at least four flange shims can include a pair of flange shims having a thickness of 10 GA and a pair of flange shims having a thickness of ¼″.

The plurality of tire pad shims can include at least four tire pad shims. The at least four tire pad shims can include a pair of tire pad shims having a thickness of 10 GA and a pair of tire pad shims having a thickness of ¼″.

The core assembly can be made entirely of galvanized steel.

The core assembly, the plurality of flange shims, and the plurality of tire pad shims can comprise galvanized steel.

A kit can be provided comprising the system described in the foregoing paragraphs.

According to a further aspect, a method of installing the system is provided. The method comprises determining a frame width of the frame, installing a flange shim from the plurality of flange shims at each end of the first part, installing a tire pad shim from the plurality of tire pad shims at each end of the second part, and bolting the core assembly together, including the flange shims, the first part, the tire pad shims, and the second part. The method can comprise bolting the core assembly to the frame.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an example of a forklift mount installation on the backend of a truck.

FIG. 2 shows an exploded view of a nonlimiting embodiment of a kit for a forklift mount, constructed according to the principles of the disclosure.

FIG. 3 shows a rear view of the kit for the forklift mount installed on the backend of a truck.

FIGS. 4-7 show partially exploded views of a portion of the kit for the forklift mount with different combinations of shims.

The present disclosure is further described in the detailed description that follows.

### DETAILED DESCRIPTION

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

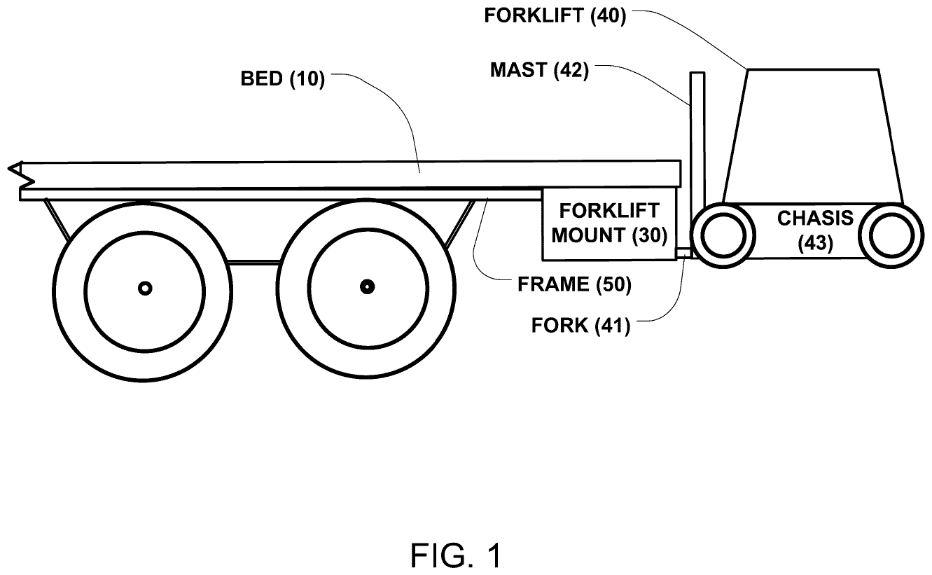

Unlike state-of-the-art (SOTA) forklift mounting kits that are cut and welded for installation, the disclosure provides a kit for forklift mount that can be bolted to any truck having, for example, a ladder frame (depicted as frame 50 in FIG. 1), by including shims to adjust for variations in frame widths. With a frame width disclosed in advance, a kit can be preassembled by shimming in the correct locations to provide a kit that matches the width of the frame. The kit allows for faster installation times, providing a galvanized solution that reduces or eliminates specialized labor for installation, such as, for example, welders.

The kit includes shims to adjust for variations in frame widths to allow installation of the core assembly without cutting or welding. This feature allows the core assembly and shims to be galvanized without the hazard of welding on galvanized steel. The kit avoids toxic fumes that can cause metal fume fever, as well as chronic zinc and lead oxide exposure that can kill.

Further, the kit avoids the hazards of cutting presently required for installation of SOTA forklift mounting kits. Truck and trailer frame widths can vary by make and model. SOTA forklift mounting kits use a cut, fit, and weld approach for installation. This requires a welder/fabricator specialist and is typically an all-day process. Welding on galvanized steel requires a specialized process, which is avoided by the kit of the instant disclosure.

In various embodiments, a system is disclosed that can be provided as a bolt-on kit for installation on trucks or trailers having different frame widths. The kit includes a plurality of flange shims, a plurality of tire pad shims, and a core assembly. In at least one embodiment, the number of flange shims equals the number of tire pad shims in the kit. In other embodiments, the number of flange shims can differ from the number of tire pad shims in the kit.

The flange shims and tire pad shims can have the same or different thicknesses. In at least one embodiment, the kit includes equal numbers of flange shims and tire pad shims having the same thickness.

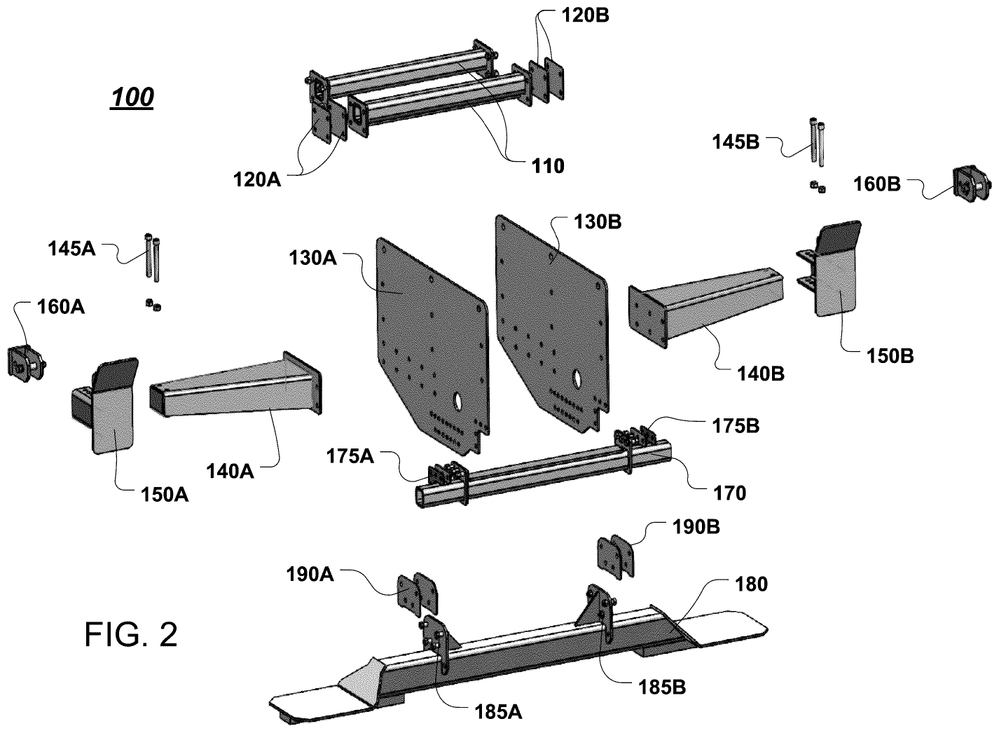

FIG. 2 shows an exploded view of a nonlimiting embodiment of a kit 100 for a forklift mount, constructed according to the principles of the disclosure. The kit 100 includes one or more bars 110, a plurality of flange shims 120, a pair of plates 130, a pair of extending members 140, a plurality of fasteners 145, a pair of tire pads 150, a pair of bed fasteners 160, a support tube 170, a plurality of tire pad shims 175, a bumper 180, a plurality of bumper mounts 185, a plurality of bumper shims 190. The parts 110 to 190 can include holes arranged to receive fasteners 145B to secure the parts 110 to 190 to each other and to the frame and/or bed of the truck.

The entire kit 100 can be made of galvanized high-strength steel, including each of the parts 110 to 190. In a non-limiting embodiment the pair of bed fasteners 160 can be made of a high-strength steel that is not galvanized.

The kit can include one or more flange shims 120, one or more tire pad shims 175, and a core assembly that includes parts 110, 130, 140, 145, 150, 160, 170, 180, 185, and 190. In an embodiment, the core assembly can be preassembled and provided with an equal number of flange shims 120 and tire pad shims 175, separate from the core assembly.

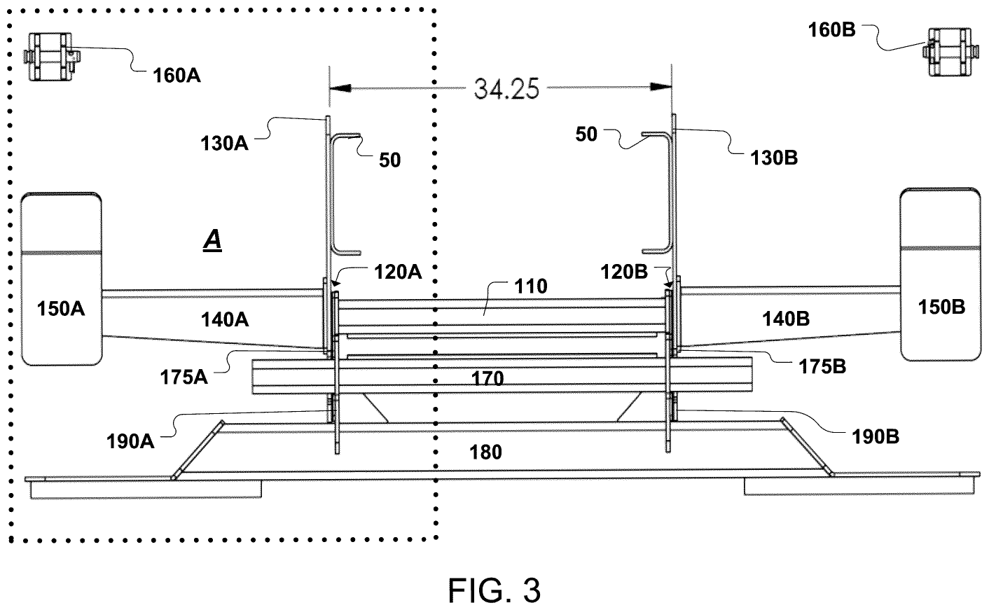

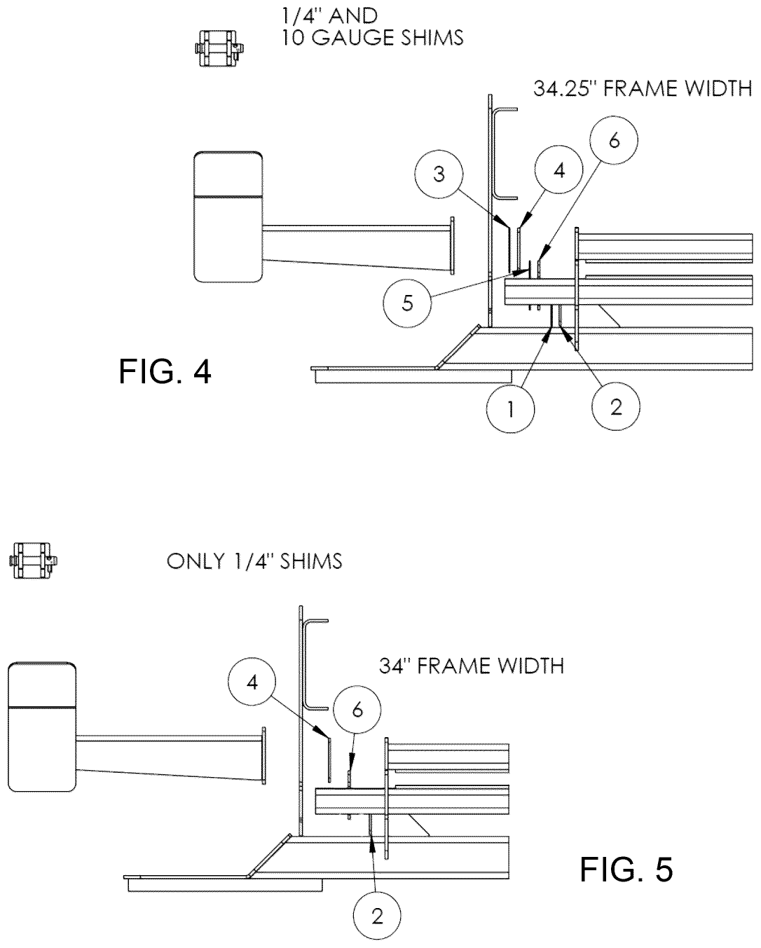

FIG. 3 shows a rear view of the kit 100 installed on the backend of a truck; and FIGS. 4-7 show partially exploded views of a portion A (shown in broken lines in FIG. 3) of the kit 100 with different combinations of shims.

Referring to FIG. 2, the bars 110 each include a flange at each distal end. Each flange includes a plurality of holes that align with holes in respective flange shims 120A or 120B and respective plates 130A or 130B, so that the flange on one end of each bar 110 can be fastened and secured to the plate 130A, either directly or with one or more flange shims 120A sandwiched between the flange and the plate 130A; and, the flange on the other end of each bar 110 can be fastened and secured to the plate 130B, either directly or with one or more flanges shims 120B sandwiched between the flange and the plate 130B.

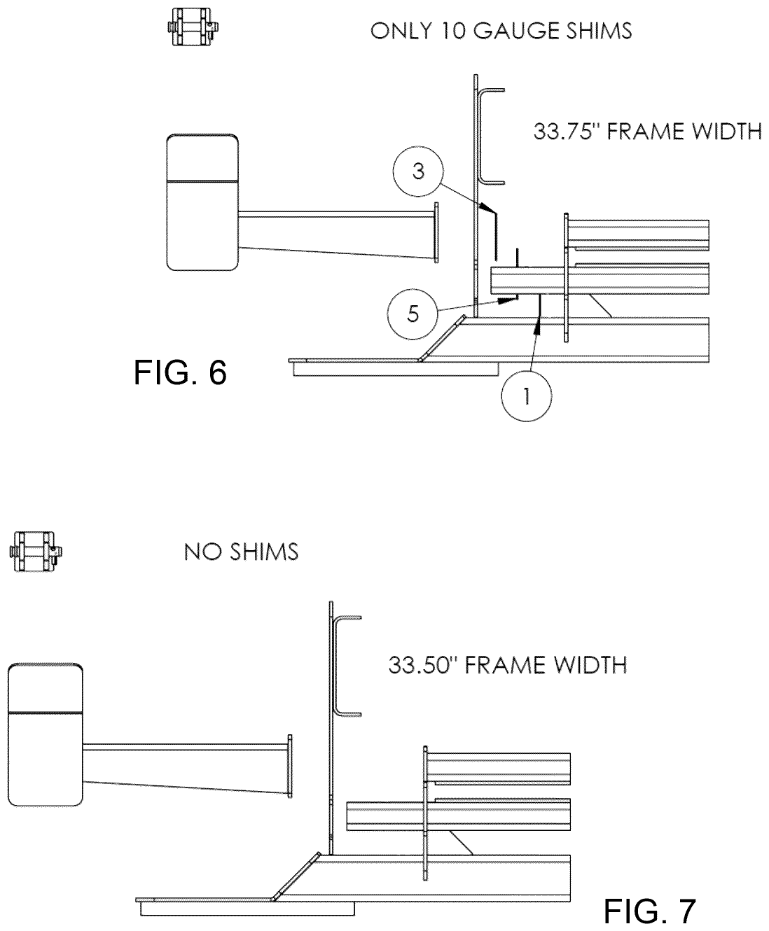

The flange shims 120 (120A and/or 120B) and tire pad shims 175 (175A and/or 175B) can include varying shapes or sizes. In the embodiment depicted in FIG. 2, the plurality of flange shims 120 and the plurality of tire pad shims 175 are each rectangularly shaped and have a thickness of one-quarter inch (¼″) or ten Gauge (10 GA). The flange shims 120 and/or tire pad shims 175 can include additional (or alternative) shims of different shapes or sizes, including thicker or thinner than ¼″ or 10 GA, depending on the installation. Any number of flange shims 120 and/or tire pad shims 175 can be used during installation, depending on the frame width of the installation, such as, for example: for a frame width of 34.25″ seen in FIG. 4, both 10 GA and ¼″ flange shims 120, identified as 3 and 4, respectively, and both 10 GA and ¼″ tire pad shims 175, identified as 1 and 2, respectively; only ¼″ flange shims 120 and ¼″ tire pad shims 175, identified as 4 and 2, respectively, in FIG. 5 for a frame width of 34″; only 10 GA flange shims 120 and 10 GA tire pad shims 175, identified as 3 and 1, respectively, in FIG. 6 for a frame width of 33.75″; or no flange shims 120 or tire pad shims 175, as seen in FIG. 7, for a frame width 33.50″.

The shapes and dimensions disclosed in this specification are nonlimiting examples provided for illustrative purposes. It is noted that the parts 110 to 190 can have other shapes or sizes (including width, height, or thickness) other than those described herein, depending on the targeted installation, which can include frame widths greater than 34.25″ or less than 33.50″. Further, the shapes and sizes of the parts 110 to 190 can be made for installation in trucks or trailers built using the metric standard, internation system of units (SI), imperial system, or the like.

The fasteners 145 can include one or more different types of fasteners, including, for example, bolts, K-bolts, hex bolts, flange bolts, square head bolts, serrated flange bolts, stud bolts, carriage bolts, or any other high-strength, durable fastener.

Referring to the embodiment depicted in FIG. 3, after assembling the kit 100 at a convenient location or ordered preassembled, such as, for example, on a workbench or the ground, the kit 100 can be installed on the truck/trailer by: bolting the plates 130A, 130B to the rails of the frame 50; fastening the bed fasteners 160A, 160B to the bed, for example, using bolts or welding; and, attaching the core assembly to the bed fasteners 160A, 160B using fasteners 145, such as, for example, pins or bolts.

The terms “a,” “an,” and “the,” as used in this disclosure, means “one or more,” unless expressly specified otherwise.

The terms “including,” “comprising” and their variations, as used in this disclosure, mean “including, but not limited to,” unless expressly specified otherwise.

Although process steps or method steps may be described in a sequential or a parallel order, such processes or methods can be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes or methods in this disclosure can be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

We claim:

1. A system for mounting a forklift to a vehicle having a frame, the system comprising:
a core assembly configured to receive and hold securely a pair of forks of a forklift;
a plurality of flange shims configured to adjust a width dimension of a first part of the core assembly to match a width of the frame; and
a plurality of tire pad shims configured to adjust a width dimension of a second part of the core assembly to match the width of the frame,
wherein the core assembly, the plurality of flange shims, and the plurality of tire pad shims are each configured to bolt to each other, and
wherein the core assembly is configured to bolt to the frame.

2. The system of claim 1, wherein the first part of the core assembly comprises a bar.

3. The system of claim 1, wherein the second part of the core assembly comprises a support tube or bumper.

4. The system of claim 1, wherein the plurality of flange shims includes at least four flange shims.

5. The system of claim 1, wherein the plurality of tire pad shims includes at least four tire pad shims.

6. The system of claim 1, wherein the plurality flange shims include at least two flange shims having a thickness of ¼″.

7. The system of claim 1, wherein the plurality flange shims include at least two flange shims having a thickness of 10 GA.

8. The system of claim 4, wherein the at least four flange shims include a pair of flange shims having a thickness of 10 GA and a pair of flange shims having a thickness of ¼″.

9. The system of claim 5, wherein the at least four tire pad shims include a pair of tire pad shims having a thickness of 10 GA and a pair of tire pad shims having a thickness of ¼″.

10. The system of claim 1, wherein the core assembly is made entirely of galvanized steel.

11. The system of claim 1, wherein the core assembly, the plurality of flange shims, and the plurality of tire pad shims comprise galvanized steel.

12. A kit comprising the system of claim 1.

13. A method of installing a forklift mount system to a vehicle having a frame, the forklift mount system including a core assembly to receive and hold securely a pair of forks of the forklift, a plurality of flange shims to adjust a width dimension of a first part of the core assembly to match a width of the frame, and a plurality of tire pad shims to adjust a width dimension of a second part of the core assembly to match the width of the frame, the method comprising:
determining a frame width of the frame;
installing a flange shim from the plurality of flange shims at each end of the first part;
installing a tire pad shim from the plurality of tire pad shims at each end of the second part; and
bolting the core assembly together, including the flange shims, the first part, the tire pad shims, and the second part, wherein the core assembly, the plurality of flange shims, and the plurality of tire pad shims are each configured to bolt to each other.

14. The method in claim 13, the method further comprising:
bolting the core assembly to the frame.

15. The method of claim 13, wherein the first part of the core assembly comprises a bar.

16. The method of claim 13, wherein the second part of the core assembly comprises a support tube or bumper.

17. The method of claim 13, wherein the plurality of flange shims includes at least four flange shims.

18. The method of claim 13, wherein the plurality of tire pad shims includes at least four tire pad shims.

19. The method of claim 17, wherein the at least four flange shims include a pair of flange shims having a thickness of 10 GA and a pair of flange shims having a thickness of ¼″.

20. The method of claim 18, wherein the at least four tire pad shims include a pair of tire pad shims having a thickness of 10 GA and a pair of tire pad shims having a thickness of ¼″.
